(19) United States
(12) Patent Application Publication
(10) Pub. No.: US 2010/0269800 A1
(43) Pub. Date: Oct. 28, 2010

(54) EXHAUST GAS RECIRCULATION COOLING CIRCUIT

(75) Inventor: Anthony Greszler, Hagerstown, MD (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: MACK TRUCKS, INC., Greensboro, NC (US)

(21) Appl. No.: 12/747,065

(22) PCT Filed: Jan. 3, 2008
(86) PCT No.: PCT/US08/00063

§ 371 Date: Jun. 9, 2010

(51) Int. Cl. F02M 25/07

(52) U.S. Cl. 123/568.12

(57) ABSTRACT

An apparatus for cooling exhaust gas for recirculation in an internal combustion engine includes a separate coolant circuit including an exhaust gas cooler connected to the engine radiator. Circulating coolant outside the engine coolant circuit results in coolant at a lower temperature being delivered to the EGR cooler under most circumstances, and therefore, improved cooling of the exhaust gas.

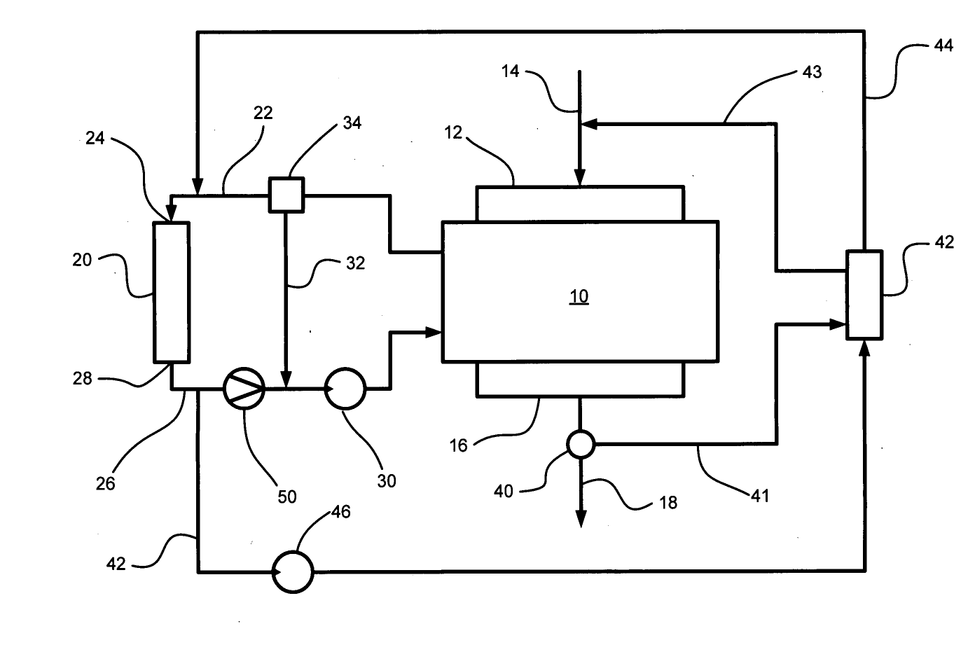

### FIELD OF THE INVENTION

The invention relates to exhaust gas recirculation systems for internal combustion engines, and more particularly, to a cooling apparatus for an exhaust gas recirculation system.

### BACKGROUND AND SUMMARY OF THE INVENTION

Exhaust gas recirculation (EGR) is used to lower combustion temperatures in internal combustion engines to reduce the formation of oxides of nitrogen (NOx) in the exhaust. Exhaust gas is diverted from the exhaust stack, cooled and filtered, and added to the engine intake air.

Known methods of cooling exhaust gas for recirculation include connecting an exhaust gas heat exchanger in the engine coolant circuit. Another known system uses an exhaust gas heat exchanger with a dedicated radiator and coolant circuit.

It is desirable to reduce the exhaust gas temperature as much as possible with least cost and space requirements.

The invention proposes an apparatus that includes a cooling circuit for an exhaust gas heat exchanger that connects to and uses the engine radiator coolant, but operates outside the circuit for cooling the engine.

The apparatus according to the invention can improve exhaust gas cooling without the additional expense and complication of a secondary radiator.

According to the invention, in an engine assembly having a circuit connected to the radiator for cooling the engine, a second loop or circuit is connected to the radiator to carry coolant to an exhaust gas heat exchanger. Under all but the highest thermal load conditions, i.e., maximum engine load, low ram air speed, and high ambient temperature, the coolant exiting the radiator is relatively cool (typically about 50° C.) prior to mixing with relatively hot coolant that bypasses the radiator via the engine thermostat. Using a second, separate circuit advantageously obtains coolant at the lowest possible temperature for cooling the exhaust gas which improves cooling of the exhaust gas. Improved cooling of the exhaust gas can improve the reduction of NOx and improve fuel economy.

An apparatus in accord with an embodiment of the invention includes a first heat exchanger or radiator for cooling engine coolant having an inlet and an outlet, a first coolant circuit having a first branch connected to carry coolant from the heat exchanger outlet to the engine and a second branch connected to carry coolant from the engine to the heat exchanger inlet, a bypass branch connected between the second branch and the first branch, a thermostat controlled valve disposed in the second branch and connected to the bypass branch for controlling coolant flow to one of the heat exchanger inlet and bypass branch, an exhaust gas cooling circuit connected to the first branch between the outlet and the bypass branch and to the second branch between the thermostat controlled valve and the heat exchanger inlet, and, a second heat exchanger for cooling exhaust gas connected in the exhaust gas cooling circuit.

According to an aspect of the invention, the apparatus further comprises a coolant pump disposed in the first branch to move coolant through the first coolant circuit.

Optionally, the apparatus includes a check valve disposed in the first branch between the exhaust gas cooling circuit and the bypass branch to prevent flow from the bypass branch to the exhaust gas cooling circuit.

According to another aspect of the invention, the apparatus includes an exhaust gas cooling circuit pump disposed in the exhaust gas cooling circuit to move coolant through the exhaust cooling circuit.

According to yet another aspect of the invention, means may be provided for controlling a flow rate of the exhaust gas cooling circuit pump to control the amount of cooling of the exhaust gas.

### BRIEF DESCRIPTION OF THE DRAWINGS

The FIGURE is a schematic representation of an embodiment of the invention of an exhaust gas recirculation cooling circuit for an internal combustion engine.

### DETAILED DESCRIPTION OF THE INVENTION

The FIGURE shows a greatly simplified schematic of an internal combustion engine 10 having an exhaust gas recirculation system with cooling in accordance with the invention. The engine 10 has an intake manifold 12 for receiving intake air 14 which is mixed with fuel and combusted, and an exhaust manifold 16 from which the products of combustion are exhausted from the engine by an exhaust stack or pipe 18.

The engine 10 has a cooling system including passages (not illustrated) in the engine through which a coolant flows. A heat exchanger or radiator 20 is connected in the cooling system to dissipate heat from the coolant. A first branch 22 of the coolant system carries coolant from the engine 10 to an inlet 24 of the radiator 20. A second branch 26 connected to an outlet 28 of the radiator 20 carries cooled coolant back to the engine 10. A pump 30, here disposed in the second branch 26, circulates the coolant through the system.

The cooling system includes a bypass branch 32 controlled by a thermostat controlled valve 34 to divert coolant from the radiator inlet 24 when the temperature of the coolant is below a threshold level, which facilitates bringing the engine to, and maintaining operating temperature.

A portion of the exhaust gas is recirculated to the engine air intake 14. The exhaust gas recirculation process is used, as is known, to reduce the formation of NOx in the combustion exhaust. A valve 40 in the exhaust conduit 18 may be used to control when and how much exhaust gas is recirculated. The recirculated exhaust gas portion is first passed by a first line 41 to an exhaust gas cooler 42 for cooling before being carried by a second line 43 to be introduced into the intake air 14.

The exhaust gas cooler 42 cools the exhaust gas by heat exchange with coolant from the engine cooling system. In accordance with the invention, coolant for exhaust gas cooler 42 is circulated in a circuit separate from the engine cooling circuit, but using the same radiator 20. The exhaust gas coolant circuit includes a first conduit 42 connected to the second branch 26 of the engine cooling system between the radiator outlet 28 and the bypass branch 32. The first conduit 42 carries cooled coolant to the exhaust gas cooler 42. A second conduit 44 is connected to the exhaust gas cooler 42 to carry heated coolant to the radiator 20 and connects to the first branch 22 between the radiator inlet 24 and the thermostat controlled valve 34.

A pump 46 is disposed in the first conduit 42 to circulate coolant through the exhaust gas coolant circuit. The pump 46 may be controlled for flow rate depending on a temperature sensed in the cooled exhaust gas or a temperature differential between coolant entering and leaving the exhaust gas cooler, to control cooling of the exhaust gas.

The exhaust gas coolant circuit thus circulates coolant directly with the radiator 20, and avoids coolant heated by the engine, to provide coolant at the lowest possible temperature to the exhaust gas cooler 42. This advantageously allows for cooler exhaust gas, which may be used more effectively in the exhaust gas recirculation system.

The exhaust gas coolant circuit may include a check valve 50 disposed in the second branch 26 between the first conduit 42 and the bypass branch 32 to prevent coolant from flowing from the bypass branch 32 into the first conduit 42 of the exhaust gas coolant circuit.

The invention has been described in terms of preferred principles, embodiments, and components, however, those skilled in the art will recognize that substitutions of equivalents may be made without departing from the scope of the invention as defined by the appended claims.

What is claimed is:

1. An apparatus for cooling exhaust gas for recirculation in an engine, comprising:
a first heat exchanger for cooling engine coolant having an inlet and an outlet;
a first coolant circuit having a first branch connected to carry coolant from the heat exchanger outlet to the engine and a second branch connected to carry coolant from the engine to the heat exchanger inlet;
a bypass branch connected between the second branch and the first branch to allow coolant to bypass the first heat exchanger;
a thermostat controlled valve disposed in the second branch and connected to the bypass branch for controlling coolant flow to one of the heat exchanger inlet and bypass branch;
an exhaust gas cooling circuit connected to the first branch between the outlet and the bypass branch and to the second branch between the thermostat controlled valve and the heat exchanger inlet; and,
a second heat exchanger for cooling exhaust gas connected in the exhaust gas cooling circuit.

2. The apparatus as claimed in claim 1, further comprising a coolant pump disposed in the first branch to circulate coolant through the first coolant circuit.

3. The apparatus as claimed in claim 1, further comprising a check valve disposed in the first branch between the exhaust gas cooling circuit and the bypass branch, the check valve preventing flow from the bypass branch to the exhaust gas cooling circuit.

4. The apparatus as claimed in claim 1, further comprising an exhaust gas cooling circuit pump disposed in the exhaust gas cooling circuit to circulate coolant through the exhaust gas cooling circuit.

5. The apparatus as claimed in claim 4, further comprising means for controlling a flow rate of the exhaust gas cooling circuit pump.
